(19) United States
(12) Patent Application Publication
(10) Pub. No.: US 2014/0008444 A1
(43) Pub. Date: Jan. 9, 2014

(54) SAMPLE-MATTER IDENTIFICATION CARD AND PROCESS OF MANUFACTURE THEREOF

(71) Applicant: Sylvain Veys, Chicago, IL (US)

(72) Inventor: Sylvain Veys, Chicago, IL (US)

(21) Appl. No.: 13/543,811

(22) Filed: Jul. 7, 2012

(51) Int. Cl. G09F 5/04; B42D 15/10; G06K 19/077

(52) U.S. Cl. CPC G09F 5/04; G06K 19/07749; B42D 15/105
USPC 235/492; 359/2; 40/124.01; 156/60

(57) ABSTRACT

A matter identification card including a card body, sample matter, and a matter descriptor; and a matter identification card including a card body, sample matter, and a matter descriptor, which may further include location information, wherein the sample matter includes a sample of a source matter, the sample matter having a size small enough to be affixed to the card body, wherein the sample matter is a portion that has been obtained from a source matter; the matter descriptor including an identifier of the matter; and a computer based method of manufacturing a sample matter identification card including acquiring a sample of a matter, positioning the sample matter onto a card body of a sample matter identification card, affixing a matter descriptor to the card body, affixing the sample matter to the card body, and adhering the sample matter and the matter descriptor to the card body.

### FIELD OF TECHNOLOGY

This disclosure relates to matter identification cards and a process of manufacturing matter identification cards.

### DESCRIPTION OF THE BACKGROUND ART

Identification cards exist that identify individuals, e.g., driver's license, government issued identification cards, etc. Other cards are used to identify matter. For example, in an educational environment, flashcards describe simple types of objects that are visible in most people's surroundings so that for example, vocabulary may be expanded. Flashcards are picture cards that include drawings or photographs of identifiable objects. People who want a more real or truer identification of real matter do not have other information easily available. Matter identification cards that include a sample of the matter do not exist. Additionally, the method of manufacturing a truer material identification card also does not exist.

A novelty card of Hiromach et. al. (U.S. Pat. No. 6,006,456) is designed to establish a monetary value of a noble metal coin, when the noble metal coin is balanced within the card. The value of the card including the noble metal coin is established by comparing the weight of the noble metal coin with the weight of the remainder of the card body. The card body is used as a weight to counterbalance the weight of the noble metal coin. The card body has a balancing center line that is used to establish when the card body and the noble metal coin are balanced in terms of weight. The card is used as a weight measurement to establish a monetary valuation of the noble metal coin.

The Hiromachi coin does not provide a small enough sample of the noble metal that allows for less costly learning or other informative reasons. The Hiromachi card does not provide matter besides noble metal matter. There is a need for a card that provides true matter identification in an efficient and easy to transfer informational setting.

### SUMMARY OF THE DISCLOSURE

A matter identification card including a card body, sample matter, and a matter descriptor, which may further include location information.

A matter identification card including a card body, sample matter, and a matter descriptor, which may further include location information, wherein the sample matter includes a sample of a source matter, the sample matter having a size small enough to be affixed to the card body, wherein the sample matter is a portion that has been obtained from a source matter; the matter descriptor including an identifier of the matter.

A computer based method of manufacturing a sample matter identification card including acquiring a sample of a matter, positioning the sample matter onto a card body of a sample matter identification card, affixing a matter descriptor to the card body, affixing the sample matter to the card body, and adhering the sample matter and the matter descriptor to the card body.

### DESCRIPTION OF THE DRAWINGS

FIG. 1 is an exemplary illustration of a sample matter identification card;

FIG. 2 is a flow diagram of an exemplary process of manufacturing a sample matter identification card, e.g., as illustrated in FIG. 1.

FIG. 3 illustrates an exemplary manufacturing system that may be used to implement the process illustrated in FIG. 2.

FIG. 4 illustrates an exemplary controller of a manufacturing process system of FIG. 3.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Identification cards exist that identify individuals, e.g., driver's license, government issued identification cards, etc. Other cards are used to identify matter. For example, in an educational environment, flashcards describe simple types of objects that are visible in most people's surroundings so that for example, vocabulary may be expanded. Flashcards are picture cards that include drawings or photographs of identifiable objects. People who want a more real or truer identification of real matter do not have other information easily available. Matter identification cards that include a sample of the matter do not exist. Additionally, the method of manufacturing a truer material identification card also does not exist.

A novelty card of Hiromach et. al. (U.S. Pat. No. 6,006,456) is designed to establish a monetary value of a noble metal coin, when the noble metal coin is balanced within the card. The value of the card including the noble metal coin is established by comparing the weight of the noble metal coin with the weight of the remainder of the card body. The card body is used as a weight to counterbalance the weight of the noble metal coin. The card body has a balancing center line that is used to establish when the card body and the noble metal coin are balanced in terms of weight. The card is used as a weight measurement to establish a monetary valuation of the noble metal coin.

The Hiromachi coin does not provide a small enough sample of the noble metal that allows for less costly learning or other informative reasons. The Hiromachi card does not provide matter besides noble metal matter. There is a need for a card that provides true matter identification in an efficient and easy to transfer informational setting.

The sample matter identification card described herein may be used to provide a sample of any matter. While the sample matter identification card described herein does not have a primary purpose of use as a monetary exchange card, the sample matter-identification card described herein may have an associated value, in addition to its informational purpose/s. Additionally, the sample matter identification card described herein may provide a plurality of information. The sample matter identification card described herein may also provide a means to easily add or update the information associated with the card.

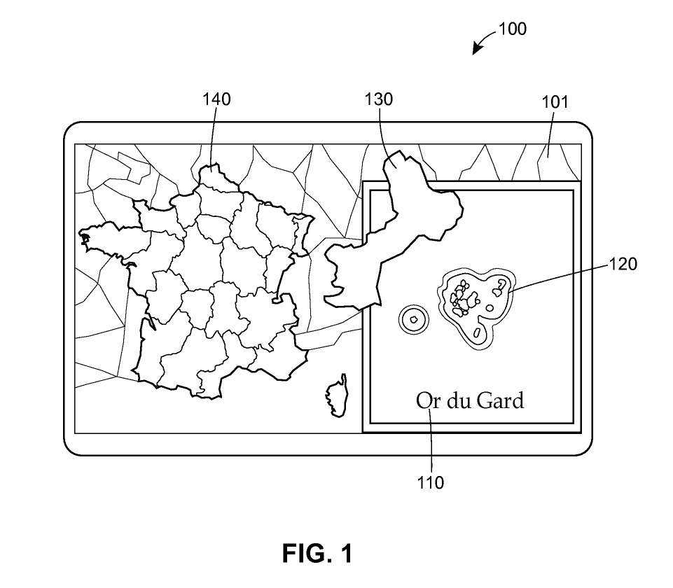

FIG. 1 illustrates an exemplary sample matter identification card 100. The card 100 includes a card body 101, a matter descriptor 110, and a portion or sample of a matter 120 (sample matter 120). The card 100 may also include location information 130.

The matter 120 is matter that is or has been reduced to a size or a sample that fits within the card 100 or may be affixed or laminated to stay on or within the card's physical area. The matter 120 may be shaved, cut, or filed to provide a usable size of matter 120. Other technologies may be used to reduce the size or portion of the matter 130. The matter 120 is small enough to be affixed to a support card or card body 101. The matter 120 may be reduced to an appropriate size that allows it to fit within the confines of the card 100 or so. The matter 120 may be laminated or affixed to stay within or on the card 100 dimensions or physical area of the card body 101.

A card body 101 may be made out of paper, plastic, cardboard, or other material capable of similar portability, size, and function. The card body 101 may be a size of a credit card, business card, flashcard, or postcard, etc. The card body 101 may be may be cut or pre-cut to any size that is small enough to have the matter identification card able to be carried around or transferred or stored.

The matter descriptor 110 may include text or other stored information. Stored information may include, for example, any one or more of the following: a memory chip, information transfer technology, electronically stored information, computer readable information, or other information that may be used to communicate the matter identification information to a person or to a computing device, such as a computer, telecommunication device, or an electronic device. The stored information may include any information described herein. The matter descriptor may be affixed or integrated with the card body 101. The matter descriptor may include physical, chemical, or biological information, or any combination of information.

The location information 130 may be similar to the matter descriptor 110 or may include map or photo information, or other information that may be used to indicate the source or location where the matter 120 may be found, e.g., geographical indication that includes a map of an area 140, including a map that identifies a location where the matter may be found. The location information 130 may include stored information similar to the matter descriptor 110, e.g., as electronically stored information.

The matter descriptor 110 may include a name or identifier of the matter or information about the physical characteristics of the matter, for example any one or more of: the weight, portion size, etc. The matter descriptor 110 may include information about the quality of the matter 120, for example in the case of diamond as the sample matter 120, color, clarity, cut, etc. The matter descriptor 110 may include information about the time the sample matter 120 was taken.

The matter descriptor 110 may include anecdote information, which may include information about, for example, any one or more of: how the matter 120 was found, with which device it was found, when it was found, where it was found, how it was downsized if it was downsized, what has been done with the rest of it that hasn't been used on that specific card, historic information, associated story, entertaining story associated with the matter, value, when it was first discovered, what it is used for, other names it may be known as, the benefits, dangers, fragility, rarity, abundance of that kind of matter, and/or any interesting fact associated with the sample matter 120, etc.

The matter descriptor 110 may also include contact information. Contact information, may include, for example, and one or more of the following: website information, phone number, or other means to contact a company, or other entity associated with the matter 120 or the card 100. The matter descriptor may also include a limited edition serial number, or other type of identification number or record.

The matter descriptor 110 may also include authenticity information, for example: proof of authenticity, etc. As stated herein, the matter descriptor 110 may also include an electronic storage device, and such storage device may store any of the information described herein and/or any more information about the card 100, its matter 120, or the source or contact associated with the card 100.

The matter descriptor 110 may also include other technology, for example, a hologram, etc. that may be made a part of the card body 101 or affixed to the card body 101.

The matter descriptor 110 may include other information transfer technology, for example, any one or more of the following: radio frequency chip technology, or other information transfer technology that may be used to communicate the matter identification information to a person or to a computing device, such as a computer, telecommunication device, or an electronic device. The matter descriptor 110 may include any other appropriate embeddable device available to store, and/or share information of interest.

The matter descriptor 110 and/or the location information 130 may be placed on either side of the card body 101, or may be placed on both sides, front and back of the card body 101. The matter 120 may be visible from either or both sides of the card body 101. The matter descriptor 110 and/or the location information 130 may be engraved or embedded into either or both sides of the card body 101.

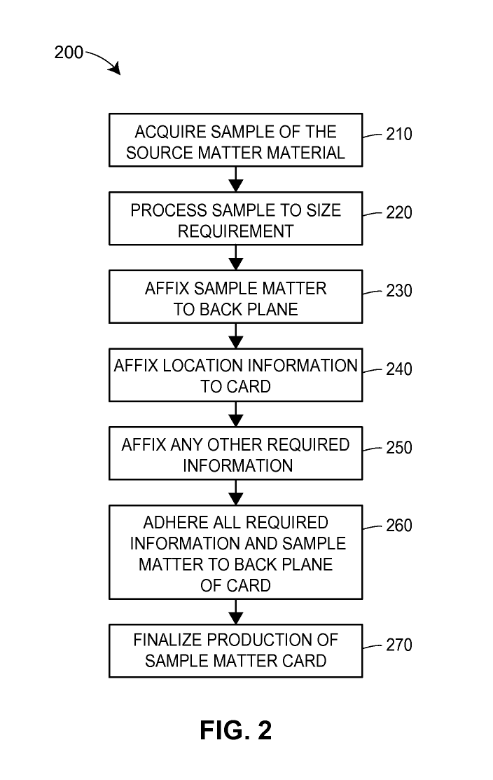

FIG. 2 illustrates an example process 200 of manufacturing a matter identification card (e.g. card 100 as described herein). For example, paper may be used as a card body 101 for the matter identification card 100. As stated herein, other materials may be used, such as plastic or other similar material/s that serves the same or similar portability and descriptive functionality described herein.

The card body 101 may be cut or pre-cut to a size. The size may be any size that is small enough to have the matter identification card 100 be able to be carried around or transferred or stored. Some example sizes are a size of a business card, a size of a postcard, etc.

The sample matter 120 or other size of matter may be sourced to a manufacturing facility prior to the performance of the manufacturing process of the matter identification card 100.

The card body 101 of the identification card 100 may be acquired from a source (block 210). The matter may be sized according to a size requirement. The sample matter 120 may be fabricated to the correct size for affixing or integrating to the card body 101 (block 220).

The sample matter 120 may be positioned anywhere on the card body 101. The sample matter 120 may be affixed or integrated (e.g., integrally-fixed, etc.) to the card body 101 (block 230).

Location information 130 may be positioned anywhere on the card body 101. Location information 130 may be affixed or integrated to the card body 101 (block 240).

Other information, for example, the matter descriptor 110 may be positioned anywhere on the card body 101. The matter descriptor 110 may be affixed or integrated to the card body 101 (block 250).

Location information 130, matter descriptor 110, or sample matter 120 may be affixed or integrated so as to be viewable by a user form the front side or the back side or both sides of the card body 101.

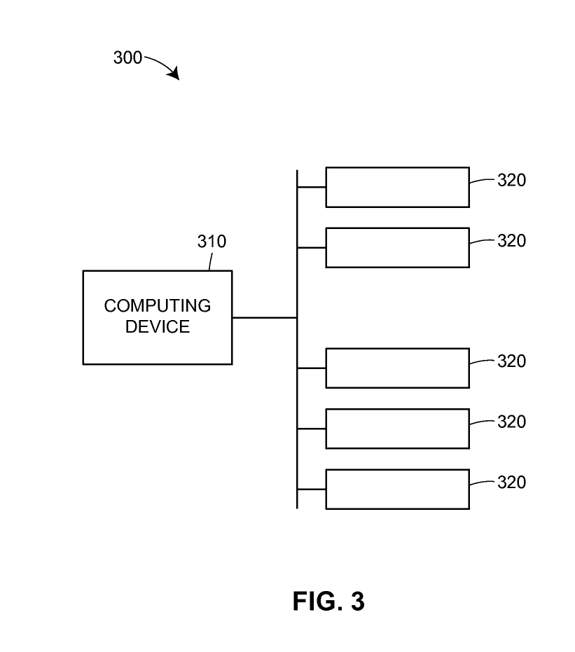

To adhere the components, a laminator device or other card-manufacturing device may be used (or any other similar device of an automated manufacture control system 300 (see. FIG. 3)) to produce the card 100 (block 260).

After all the required components (e.g., sample matter 120, location information 130, matter descriptor 110, etc.) are affixed or integrated, and adhered to the card body 101, the card 100 may be finalized with other production methods (block 270).

In the case where the matter descriptor includes electronically stored information, and when more or updated information is available about the card 100 or the matter 120, the process may include updating the electronically stored information remotely via a telecommunication device.

FIG. 3 illustrates an exemplary manufacturing system 300 that may be used to manufacture the matter identification card 100 using the exemplary manufacturing process 200. The manufacturing system 300 includes a controller 310, which may be a controller or a computing device 310 that controls other manufacturing devices 320, which may include robotic assembler devices, etc. The other devices in the system may include any locally or distributed controlled devices 320, which may be used to perform the process 200. For example, a robotic device may control the physical maneuvering of the physical components of the sample matter identification card 100. For example, any hardware/software devices/systems that are available at the time of the invention and after is covered by the disclosure. In an effort to stay within practical considerations, the disclosure is directed toward the most inventive aspects of the disclosure, as the non-disclosed technology is available to those with ordinary skill in the art.

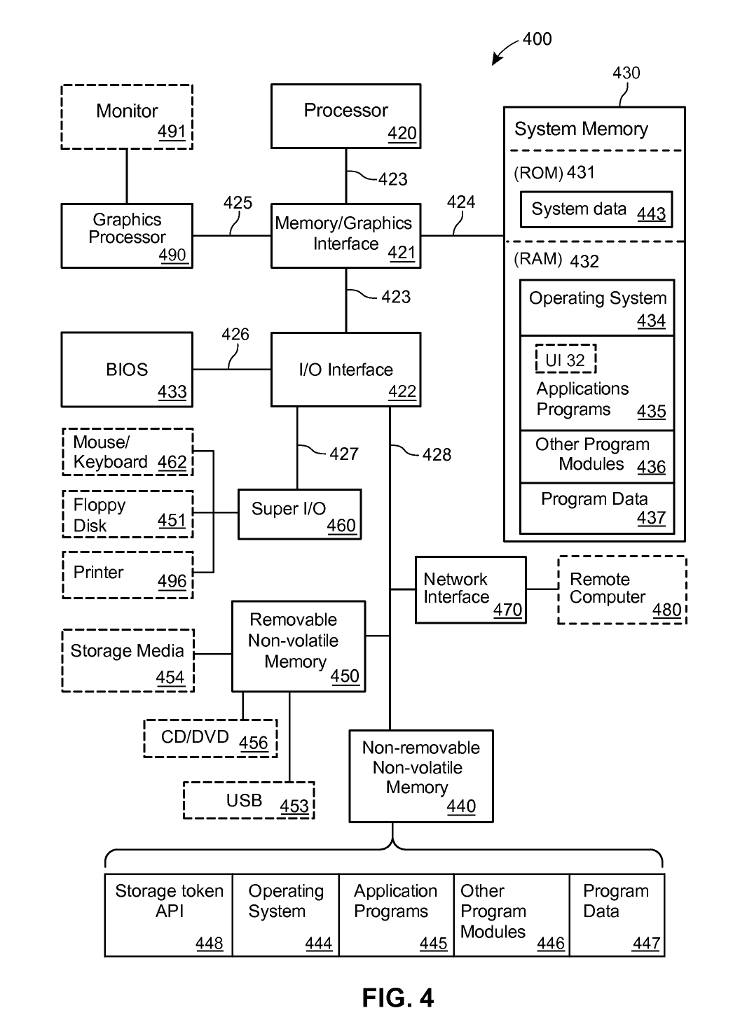

FIG. 4 illustrates components of an exemplary computing device 310, here labeled 400, of the manufacturing process system, e.g., system 300. Components shown in dashed outline are not technically part of the computing device 400, but are used to illustrate the exemplary embodiment of FIG. 4. Components of computing device 400 may include, but are not limited to, a processor 420, a system memory 430, a memory/graphics interface 421, also known as a Northbridge chip, and an I/O interface 422, also known as a Southbridge chip. The system memory 430 and a graphics processor 490 may be coupled to the memory/graphics interface 421. A monitor 491 or other graphic output device may be coupled to the graphics processor 490.

A series of system busses may couple various system components including a high speed system bus 423 between the processor 420, the memory/graphics interface 421 and the I/O interface 422, a front-side bus 424 between the memory/graphics interface 421 and the system memory 430, and an advanced graphics processing (AGP) bus 425 between the memory/graphics interface 421 and the graphics processor 490. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport™ architecture, respectively.

The computing device 400 may include a variety of computer readable media. Computer readable media may be any available media that may be accessed by computer 400 and includes any combination volatile, nonvolatile media, removable, and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 400.

The system memory 430 may include computer storage media in the form of volatile and/or nonvolatile memory such as read only memory (ROM) 431 and random access memory (RAM) 432. The system ROM 431 may contain permanent system data 443, such as identifying and manufacturing information. In some embodiments, a basic input/output system (BIOS) may also be stored in system ROM 431. RAM 432 typically contains data and/or program modules that are immediately accessible to and/or presently being operated on by processor 420. By way of example, and not limitation, FIG. 4 illustrates operating system 434, application programs 435, other program modules 436, and program data 437. An embodiment of the disclosure may have a user interface module stored in the applications programs 435 storage area. The user interface module may be stored in the applications program storage area 435 also, or may be distributed throughout other storage devices on the computer system 300 or across a network. The user interface module may also be stored in other storage locations of the computer system 300 or across a network.

The I/O interface 422 may couple the system bus 423 with a number of other busses 426, 427 and 428 that couple a variety of internal and external devices to the computer 400. A serial peripheral interface (SPI) bus 426 may connect to a basic input/output system (BIOS) memory 433 containing the basic routines that help to transfer information between elements within computer 400, such as during start-up.

A super input/output chip 460 may be used to connect to a number of ‘legacy’ peripherals, such as floppy disk 452, keyboard/mouse 462, and printer 496, as examples. The super I/O chip 460 may be connected to the I/O interface 422 with a bus 427, such as a low pin count (LPC) bus, in some embodiments. Various embodiments of the super I/O chip 460 are widely available in the commercial marketplace.

In one embodiment, bus 428 may be a Peripheral Component Interconnect (PCI) bus, or a variation thereof, may be used to connect higher speed peripherals to the I/O interface 422. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 428 may be an advanced technology attachment (ATA) bus, in the form of a serial ATA bus (SATA) or parallel ATA (PATA).

The computer 400 may also include other removable/non-removable, volatile/nonvolatile computer storage media. By way of example only, FIG. 4 illustrates a hard disk drive 440 that reads from or writes to non-removable, nonvolatile magnetic media. The hard disk drive 440 may be a conventional hard disk drive or may be similar to the storage media.

Removable media, such as a universal serial bus (USB) memory 453, firewire (IEEE 1394), or CD/DVD drive 456 may be connected to the PCI bus 428 directly or through an interface 450. A storage media 454 may coupled through interface 450. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 4, provide storage of computer readable instructions, data structures, program modules and other data for the computer 400. In FIG. 4, for example, hard disk drive 440 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 20 through input devices such as a mouse/keyboard 462 or other input device combination. Other input devices (not shown) may include a microphone, joystick, game pad, satellite dish, scanner, or the like. These and other input devices are often connected to the processor 420 through one of the I/O interface busses, such as the SPI 426, the LPC 427, or the PCI 428, but other busses may be used. In some embodiments, other devices may be coupled to parallel ports, infrared interfaces, game ports, and the like (not depicted), via the super I/O chip 460.

The computer 400 may operate in a networked environment using logical connections to one or more remote computers, such as a remote computer 480 via a network interface controller (NIC) 470. The remote computer 480 may be a personal computer, a server, a router, a network PC, a peer device or other common network node, and typically includes many or all of the elements described above relative to the computer 400. The logical connection between the NIC 470 and the remote computer 480 depicted in FIG. 1 may include a local area network (LAN), a wide area network (WAN), or both, but may also include other networks. Such networking environments are commonplace in offices, enterprise-wide computer networks, intranets, and the Internet. The remote computer 480 may also represent a web server supporting interactive sessions with the computer 400.

In some embodiments, the network interface may use a modem (not depicted) when a broadband connection is not available or is not used. It will be appreciated that the network connection shown is exemplary and other means of establishing a communications link between the computers may be used.

The way a user interfaces with a computer has evolved. Initially, computers had an electronic user interface which was a line prompt where users were expected to know a computer specific language or script. Such knowledge required the user to have a computer directed technical education in order to interface with a computer. Computer interfaces became more user-friendly with the advent of windows type user interfaces, such as icons, point and click, menus, task panes, tabs, scroll buttons, pop-up windows, toggles, etc.

1-42. (canceled)

43. A matter identification card comprising:
a card body;
sample matter; and
a matter descriptor.

44. A matter identification card according to claim 43, further including location information.

45. A matter identification card according to claim 43, further including location information,
wherein the sample matter includes a sample of a source matter, the sample matter having a size small enough to be affixed to the card body,
wherein the sample matter is a portion that has been obtained from a source matter;
the matter descriptor including a name of the matter.

46. A matter identification card according to claim 43,
wherein the card body is pre-cut to a size of any one of the following: size of a credit card, size of a business card, size of a flashcard, or size of a postcard.

47. A matter identification card according to claim 43,
wherein the matter descriptor includes stored information.

48. A matter identification card according to claim 43,
wherein the matter descriptor includes electronically stored information including computer readable information.

49. A matter identification card according to claim 43, further including location information,
wherein the sample matter includes a sample of a source matter, the sample matter having a size small enough to be affixed to the card body,
wherein the sample matter is a portion that has been obtained from a source matter;
wherein the sample matter is a result of any one of a shaved, cut, or filed source matter.

50. A matter identification card according to claim 43, further including location information,
wherein the sample matter is a portion that has been obtained from a source matter;
wherein the sample matter is a result of any one of a shaved, cut, or filed source matter;
wherein the location information includes a map of an area where the sample matter may be found.

51. A matter identification card according to claim 43, further including location information,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes information about the physical characteristics of the matter.

52. A matter identification card according to claim 43,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes information about the physical characteristics of the matter;
wherein the matter descriptor includes anecdote information.

53. A matter identification card according to claim 43,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes information about the physical characteristics of the matter;
wherein the matter descriptor includes anecdote information;
wherein the matter descriptor includes contact information.

54. A matter identification card according to claim 43, further including location information,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes information about the physical characteristics of the matter;
wherein the matter descriptor includes anecdote information;
wherein the matter descriptor includes contact information.

55. A matter identification card according to claim 43, further including location information,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes information about the physical characteristics of the matter;
wherein the matter descriptor includes contact information.

56. A matter identification card according to claim 43, further including location information,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes information about the physical characteristics of the matter;
wherein the matter descriptor includes contact information;
wherein the matter descriptor includes proof of authenticity.

57. A matter identification card according to claim 43, further including location information,
wherein the sample matter is a portion that has been obtained from a source matter;
wherein the sample matter is a result of any one of a shaved, cut, or filed source matter;
wherein the location information includes a map of an area where the sample matter may be found;
wherein the matter descriptor includes a hologram.

58. A matter identification card comprising:
a card body;
sample matter; and
a matter descriptor, and location information;
wherein the sample matter includes a sample of a source matter, the sample matter having a size small enough to be affixed to the card body,
wherein the sample matter is a portion that has been obtained from a source matter;
the matter descriptor including an identifier of the matter.

59. A matter identification card according to claim 58,
wherein the card body includes a front side and a back side;
wherein any of the matter descriptor, location information, and sample matter may be visible by a user viewing the front side or the back side of the card.

60. A computer based method of manufacturing a sample matter identification card comprising:
acquiring a sample of a matter;
positioning the sample matter onto a card body of a sample matter identification card;
affixing a matter descriptor to the card body; affixing the sample matter to the card body; and
adhering the sample matter and the matter descriptor to the card body.

61. A method according to claim 60,
affixing and adhering location information onto the card body, and finalizing the production of the matter identification card.

62. A method according to claim 60,
wherein the matter descriptor includes electronically stored information; and the method further includes
updating the electronically stored information remotely via a telecommunication device.
